(19) United States
(12) Patent Application Publication
(10) Pub. No.: US 2023/0245219 A1
(43) Pub. Date: Aug. 3, 2023

(54) OPTION FOR PURCHASING A VEHICLE

(71) Applicant: Claiton Inc, Austin, TX (US)

(72) Inventor: Benjamin Roy Bell, Pflugerville, TX (US)

(21) Appl. No.: 18/104,933

(22) Filed: Feb. 2, 2023

Related U.S. Application Data
(60) Provisional application No. 63/306,255, filed on Feb. 3, 2022.

(51) Int. Cl. G06Q 30/0601; G06Q 30/0283; G06Q 30/08; G06Q 30/04

(52) U.S. Cl. CPC G06Q 30/0641; G06Q 30/0283; G06Q 30/08; G06Q 30/04

(57) ABSTRACT

Various embodiments of the present disclosure include a method for purchasing a vehicle. In some embodiments, the method can include receiving an indication that a vehicle is damaged beyond repair. In some embodiments, the method can include receiving data related to the damaged vehicle. In some embodiments, the method can include determining a price for an option to purchase the damaged vehicle, wherein the price for the option to purchase the damaged vehicle is unique to the particular damaged vehicle and is determined based on the received data. In some embodiments, the method can include causing the price for the option to purchase the damaged vehicle to be presented to a user, along with at least some of the received data. In some embodiments, the method can include receiving a selection from the user to buy the option to purchase the damaged vehicle.

### BACKGROUND

### a. Field

This disclosure relates to a system and method for an option for purchasing a vehicle.

### b. Background Art

Based on an amount of damage sustained to a vehicle as a result of an insurable event (e.g., accident), an insurance company that insures the vehicle will generally proceed in one of several ways. If the damage to the vehicle does not exceed the residual value of the vehicle, the insurance companies will generally pay to have the vehicle repaired. However, where damage to the vehicle exceeds the residual value of the vehicle, the insurance company will generally consider the vehicle irreparable and take possession of the vehicle, assigning the vehicle a salvage title. To do this, the insurance company takes possession of the vehicle, paying off any current lienholder and records the title in the insurance company's name. The insurance company then obtains a salvage title, which is typically completed through a jurisdiction's department of motor vehicles. The damaged motor vehicle can then be sold to a third party with the salvage title. From there, the third party may repair the vehicle to a roadworthy condition, resell the vehicle, and/or keep the vehicle for their own use. However, in some instances, the third party may strip the vehicle for parts, which can be sold, or sell the vehicle as scrap metal.

The whole process, from when the vehicle is initially damaged (e.g., in an accident), to when the vehicle is sold by the insurance company with the salvage title can typically take anywhere from 60 to 100 days, if not longer. During this time, the insurance company needs to pay for storage for the vehicle and transport the vehicle to the location where the vehicle will be stored. Oftentimes, the vehicles are stored at outdoor locations, which are subject to the elements, including heat, cold, rain, snow, and/or dust. In some examples, the vehicles can be further damaged, as a result of being exposed to the elements. For instance, vehicles can have damage to windows, seals, etc., which can allow for further exposure of an interior of the vehicle to the elements, causing related damage.

When the vehicle with salvage title is eventually sold to a third party, the vehicle is moved yet again to a location chosen by the third party. Every time the vehicle is moved, first to the storage facility and then to the location chosen by the third party, the chance that the vehicle can be damaged increases. Embodiments of the present disclosure can provide solutions to at least the problems set forth above.

### SUMMARY

Various embodiments of the present disclosure include a method for purchasing a vehicle. In some embodiments, the method can include receiving an indication that a vehicle is damaged beyond repair. In some embodiments, the method can include receiving data related to the damaged vehicle. In some embodiments, the method can include determining a price for an option to purchase the damaged vehicle, wherein the price for the option to purchase the damaged vehicle is unique to the particular damaged vehicle and is determined based on the received data. In some embodiments, the method can include causing the price for the option to purchase the damaged vehicle to be presented to a user, along with at least some of the received data. In some embodiments, the method can include receiving a selection from the user to buy the option to purchase the damaged vehicle.

Various embodiments of the present disclosure include a method for purchasing a vehicle. In some embodiments, the method can include receiving an indication that a plurality of vehicles are damaged beyond repair. In some embodiments, the method can include receiving data related to the plurality of damaged vehicles, wherein the data associated with each of the vehicles is unique to the respective vehicle. In some embodiments, the method can include determining a price for an option to purchase each of the damaged vehicles, wherein the price for the option to purchase each of the damaged vehicles is unique to each particular damaged vehicle and is determined based on the associated unique data. In some embodiments, the method can include causing the price for the option to purchase the damaged vehicle to be displayed to a user, along with at least some of the received data. In some embodiments, the method can include receiving a selection from the user to buy the option to purchase the damaged vehicle.

Various embodiments of the present disclosure include a non-transitory computer-readable medium storing instructions to purchase a vehicle. In some embodiments, the instructions can be executed to receive data related to a damaged vehicle, wherein the cost of damage to the vehicle exceeds a residual value of the vehicle. In some embodiments, the instructions can be executed to determine a price for an option to purchase the damaged vehicle, wherein the price for the option to purchase the damaged vehicle is unique to the particular damaged vehicle and is determined based on the received data. In some embodiments, the instructions can be executed to present the option to purchase the damaged vehicle to a user. In some embodiments, the instructions can be executed to determine an eligibility of the buyer to purchase the option. In some embodiments, the instructions can be executed to receive a selection from the buyer to purchase the option, based on their determined eligibility to purchase the option.

### BRIEF DESCRIPTION OF THE DRAWINGS

FIG. 1 depicts an example of an environment which can be implemented for purchasing a vehicle, according to embodiments of the present disclosure.

FIG. 2 depicts a method flow diagram for purchasing a vehicle, according to embodiments of the present disclosure.

FIG. 3 depicts a flow chart for purchasing a vehicle, according to embodiments of the present disclosure.

FIG. 4A depicts a diagram of a system for purchasing a vehicle, according to embodiments of the present disclosure.

FIG. 4B depicts a diagram of an example of a computing device for purchasing a vehicle, according to embodiments of the present disclosure.

### DETAILED DESCRIPTION

As discussed herein, the process from when a vehicle is damaged to when a salvage title can be produced for the damaged vehicle, such that the vehicle can be sold, currently takes anywhere from 60 to 100 days, depending on a particular jurisdiction in which the vehicle is titled. During this time, the vehicle can be transported multiple times, generally between an adjuster, a third-party storage facility, and ultimately to a buyer of the vehicle, once a salvage title has been obtained. During the majority of this time, the vehicle is stored at the third-party storage facility, which introduces a number of additional costs (e.g., storage fees). Oftentimes, the damaged vehicle is stored outdoors at the storage facility, further subjecting the vehicle to damage from the elements. During the 60 to 100 day window during which the salvage title is being procured, the value of the vehicle can drop, due not only to depreciation, but to further damage incurred to the vehicle from transporting the vehicle to and from the third-party storage facility and from the vehicle being subjected to the elements.

Embodiments of the present disclosure can utilize the systems, methods, and computing devices, as disclosed herein to improve upon the present process for dealing with salvaged vehicles, thus preventing further depreciation and/or damage to the vehicles and to better provide an insurance company selling the salvaged vehicle with an accurate amount for which the vehicle will be sold.

In some embodiments of the present disclosure, a third-party storage facility, which stores salvaged vehicles awaiting their salvage title, can be bypassed. For example, in some embodiments, a unique option to purchase the damaged vehicle can be provided to a prospective buyer for a price. In some embodiments, the prospective buyer can choose whether or not to exercise the unique option at the time the salvage title is ready for the damaged vehicle. For example, the unique option can be a conditional option to purchase the damaged vehicle, which is conditional on a title being procured for the vehicle; the title for which can in some embodiments be a salvage title, a nonrepairable vehicle title, or a clean title.

In some embodiments, the prospective buyer may have a particular time period in which they can choose to exercise the option to purchase the damaged vehicle (e.g., 5 days). The price for the unique option to purchase the damaged vehicle can be determined based on data associated with the vehicle, as discussed herein. Thus, the option to purchase the damaged vehicle is specifically unique to that particular damaged vehicle.

Upon purchase of the unique option, the prospective buyer can agree to take possession of the vehicle, thereby bypassing the third-party storage facility. This reduces the number of times that the vehicle needs to be transported, as well as fees associated with the third-party storage facility. Furthermore, the potential buyer can chose how to store the vehicle, whether indoors or otherwise, to prevent any further damage to the vehicle from the elements. Embodiments of the present disclosure can also allow for the potential buyer to perform a detailed inspection of the vehicle, such that they can be better informed in making a decision of whether they would like to exercise their option to buy the vehicle, something that is lacking in current processes. When the salvage title becomes available, the potential buyer can choose whether or not to exercise the option. If the potential buyer does choose to exercise the option, the amount paid for the option can be applied to the purchase price of the vehicle.

In accordance with embodiments of the present disclosure, by providing a unique option to purchase the damaged vehicle, an insurance company that insures the damaged vehicle will be able to know the price that the vehicle will eventually sell for much sooner, assuming that the buyer exercises the unique option. For example, the insurance company will be able to price the vehicle within a few days of the vehicle being damaged, rather than having to try to estimate the value of the vehicle at a time up to 100 days from when the vehicle is damaged, when the salvage title becomes available and the vehicle can be sold. Once the insurance company decides what to charge for the price of the vehicle, that price is locked in, adding predictability for the insurance company. Once the buyer purchases the unique option, the insurance company will know in advance what the vehicle will sell for when the option is exercised. In some embodiments, although the above discussion is centered around the insurance company setting a price of the vehicle, in some embodiments, an auction provider could set the price of the vehicle. In some embodiments, the price of the vehicle can be set by bidders of an auction held by the auction provider. Regardless of how the price of the vehicle and/or the price of the unique option is determined, the insurance company will know the price that the vehicle will sell for upon exercising of the unique option much sooner than in prior methods that did not sell the vehicle until the salvage title was obtained. Even if only 95% of unique options for damaged vehicles are eventually executed, the insurance company will be able to know in advance the price for what 95% of the damaged vehicles will be sold. Further embodiments of the present disclosure will be apparent upon review of the disclosure included herein.

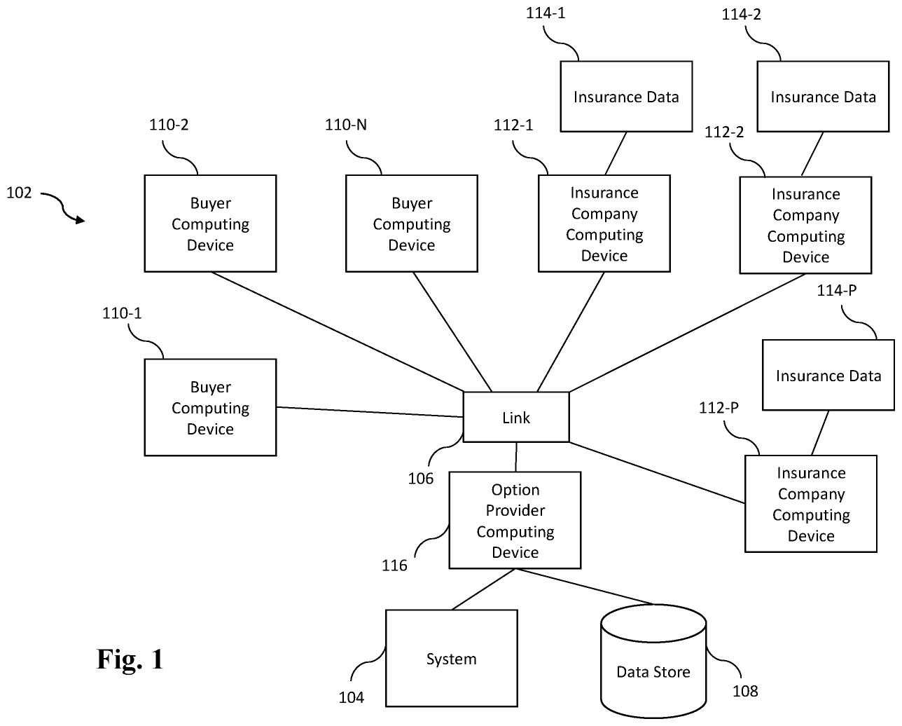

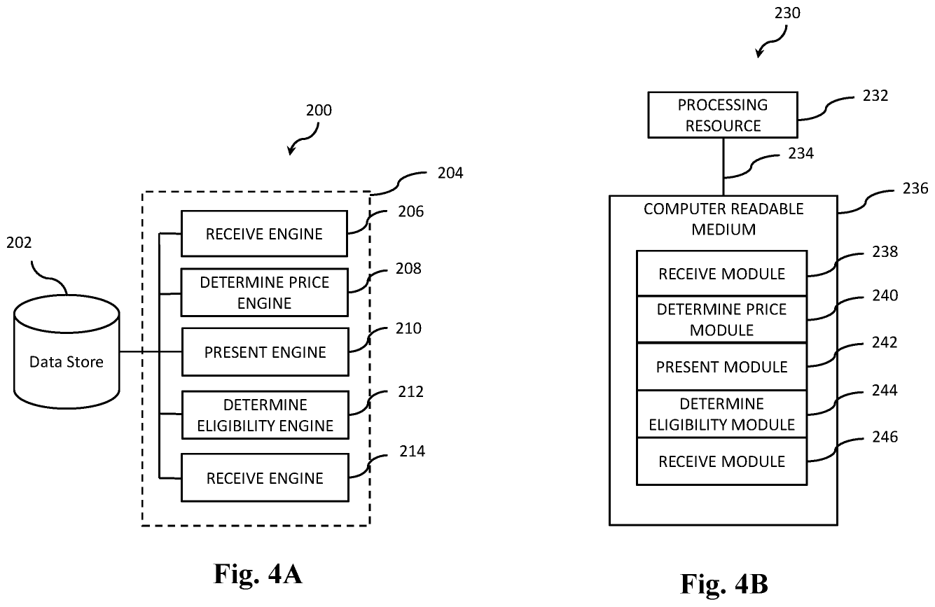

FIG. 1 depicts an example of an environment 102, which can be implemented for purchasing a vehicle, according to embodiments of the present disclosure. The environment 102 is shown to include a system 104 to purchase a vehicle, buyer computing devices 110-1, 110-2, . . . , 110-N, insurance company computing devices 112-1, 112-2, . . . , 112-P, a data store 108, and a link 106, and option provider computing device 116. The data store 108 can be analogous to those discussed herein and with respect to FIG. 4A. The system 104 can include a computing device analogous to that discussed herein and with respect to FIG. 4B. The buyer computing devices 110-1, . . . , 110-N, insurance company computing devices 112-1, . . . , 112-P, and option provider computing devices 116, as described herein, can be computing devices (e.g., electronic devices) and include, for example, features discussed below in relation to the system 104. In some embodiments, the computing devices can include a digital display such as a graphical user interface (GUI), which is suitable for the display of electronic data.

A graphical user interface can include hardware components and/or computer-readable instruction components. For instance, hardware components can include input components (e.g., a mouse, a touchscreen, a keyboard, dials and buttons, etc.) and/or output components (e.g., a display, vibration generating devices, speakers, etc.). An example user interface can include a GUI, which can digitally represent data associated with facilitating a transaction. That is, in some examples, an electronic representation can be displayed by a user interface associated with buyer computing devices 110-1, . . . , 110-N, seller computing devices 112-1, . . . , 112-P, and/or option provider computing devices. Such displays can facilitate interactions between a user and a computer (e.g., allows a user to interact with a computer using images and/or text).

Link 106 (e.g., local, wide area, regional, or global network) represents a cable, wireless, fiber optic, or remote connection via a telecommunication link, an infrared link, a radio frequency link, and/or other connectors or systems that provide electronic communication. That is, the link 106 can, for example, include a link to an intranet, the Internet, or a combination of both, among other communication interfaces. The link 106 can also include intermediate proxies, for example, an intermediate proxy server (not shown), routers, switches, load balancers, and the like.

The system 104 for purchasing a vehicle, as described herein, can represent different combinations of hardware and instructions to purchase a vehicle. The system 104 for purchasing a vehicle can include a computing device, for instance, computing device 230, as discussed in relation to FIG. 4B. The system 104 can be used in the execution of the process of purchasing a vehicle, as further discussed herein.

In some embodiments, one or more insurance company computing devices 112-1, 112-2, . . . , 112-P, hereinafter referred to in the plural as insurance company computing devices 112, can be in communication with an option provider computing device 116, via the link 106. In some embodiments, a vehicle insured by one or more insurance companies associated with the insurance company computing devices 112 can be damaged. As used herein, vehicle can include any type of motorized or unmotorized mode of transportation, including automobiles, boats, airplanes, helicopters, motorcycles, all-terrain vehicles, snowmobiles, construction equipment, etc. Based on the damage to the vehicle, typically made by an adjuster, an assessment of the amount and cost of the damage can be made. Where the cost of the damage exceeds a residual value for the vehicle, oftentimes, an assessment can be made by the insurance company that the vehicle is to be salvaged. In some embodiments, insurance data 114-1, 114-2, . . . , 114-3, stored in one or more databases can be accessed by the insurance company to make the determination. The insurance data can in some embodiments be data that is uploaded to the database by an insurance adjuster, although the data can be uploaded by other parties, including the owner of the vehicle, police, auto repair company, etc. In some embodiments of the present disclosure, upon making a determination that the vehicle is damaged beyond repair, a price for an option to purchase the vehicle can be determined.

In some embodiments, the price for the option to purchase the vehicle can be determined by the option provider computing device 116. In some embodiments, the price for the option to purchase the damaged vehicle can be unique to the particular damaged vehicle. For example, in some embodiments, the option to purchase the damaged vehicle can be determined based on a residual value associated with the damaged vehicle. Accordingly, because the characteristics of each damaged vehicle are unique to that particular vehicle, a purchase price for the option to purchase the damaged vehicle can also be unique. For example, out of a plurality of damaged vehicles, each damaged vehicle can have a different age, different damage, different condition. Furthermore, out of the plurality of damaged vehicles, each vehicle can be of a different make, different model, etc. Thus, the unique features associated with each damaged vehicle can result in the determination by the option provider computing device 116 of an option purchase price that is unique to the particular damaged vehicle and can be determined based on data received from the data store 108. In some embodiments, the determination can be made directly from data provided from insurance data 114-1, 114-2, . . . , and/or 114-P.

In some embodiments, a price for the purchase option for the vehicle can be a flat price. Accordingly, the price for the purchase option may not vary between vehicles. In some embodiments, the price for the purchase option can be graduated for vehicles selling between different price ranges. For example, in some embodiments, different option prices can be assigned for vehicles selling between different price ranges. For example, a first option price can be assigned for vehicles selling between $250 and $500, a second option price for vehicles selling between $500 and $1,000, a third option price for vehicles selling between $1,000 and $1,500, etc. In some embodiments, the price of the vehicle can be determined at auction. For example, in some embodiments, an auction provider can determine a minimum bid price and/or reserve for the vehicle before auctioning commences, with an ultimate sale price determined by bidders. In some embodiments, no minimum bid price and/or reserve can be determined by the auction provider and the ultimate sale price can be determined by bidders. Accordingly, in some embodiments, the option price can be determined based on an auction price for which the vehicle sold.

In some embodiments, the option purchase price can be presented to one or more users (e.g., prospective buyers), via a buyer computing device 110-1, 110-2, . . . , 112-N. Furthermore, some or all of the data used in the determination of the option purchase price can be presented to the user, via the buyer computing device, for their consideration. In an example, details associated with a year, make, model, mileage, damage, etc. can be presented to the user. In some embodiments, photos of the damaged vehicle can be presented to the user.

In some embodiments, a selection can be received from the user to buy the option to purchase the damaged vehicle. For example, the selection can be received from the user to buy the option to purchase the damaged vehicle with the option provider computing device 116. In some embodiments, the user can make a selection to purchase the damaged vehicle for a particular price. For example, the damaged vehicle can be auctioned and the winning bidder can make a selection to purchase the vehicle at the price of their winning bid. In some embodiments, a price of the option to purchase the damaged vehicle can be based on the amount of the winning bid. In an example, as discussed herein, in some embodiments the price of the option to purchase the damaged vehicle can be graduated, based on purchase price of the vehicle. For instance, a price of the option to purchase the damaged vehicle can increase with an increasing purchase price (e.g., bid amount) of the vehicle. In some embodiments, the option price can be based on a residual value of the vehicle. For example, in some embodiments, an option provider can determine a residual value of the damaged vehicle and the price for the option to purchase the damaged vehicle can be based on the determined residual value of the vehicle.

In some embodiments, as a result of the user buying the option to purchase the damaged vehicle, the user can take possession of the damaged vehicle until the salvage title becomes available. As a result, the user can be free to choose how they store the vehicle and inspect the vehicle to accurately make their own determination with respect to the value of the vehicle, so they can choose whether to exercise the option to purchase the vehicle.

In some embodiments, the auction provider can be a third party unrelated to the insurer and the prospective buyer. In some embodiments, the auction provider and/or another facilitating third party can be responsible for one or more of coordinating the sale of the damaged vehicle (e.g., through an auction), facilitating the title transfer process, obtaining payment for the option to purchase the vehicle from the prospective buyer, assessing fees to the prospective buyer for delay in moving the vehicle from the insurer's possession, coordinating shipping and/or pickup arrangements associated with the damaged vehicle. In some embodiments, the auction provider and/or facilitating third party can be compensated via a fee paid for auctioning of the damaged vehicle, regardless of whether the option to purchase the vehicle is exercised. In some embodiments, an additional fee can be paid to the auction provider and/or the facilitating third party should the option to purchase the damaged vehicle be exercised. In an example, the fee can be a flat fee and/or can be a percentage fee, in some embodiments.

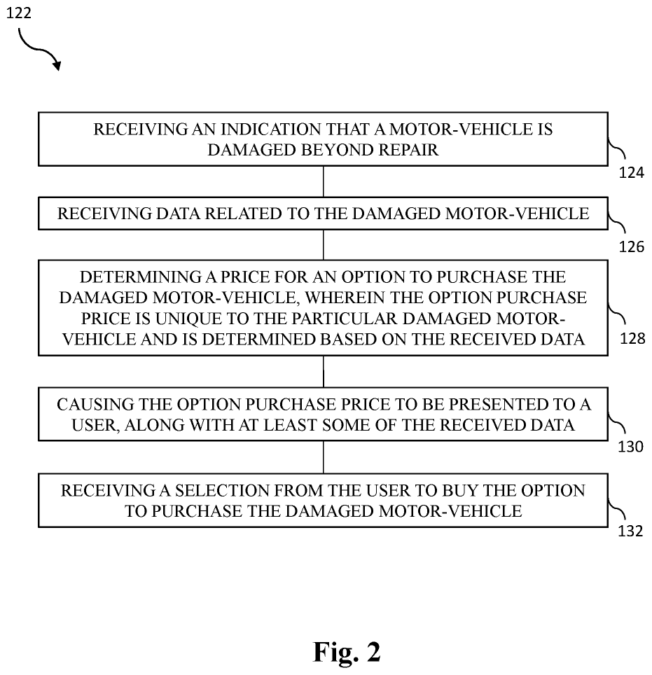

FIG. 2 depicts a method flow block diagram 122 for purchasing a vehicle, in accordance with embodiments of the present disclosure. In some embodiments, one or more of the individual steps in the method flow block diagram 122 can represent method steps, which can be executed by the one or more computing devices discussed herein. As depicted in method block 124, the method 122 can include receiving an indication that a motor-vehicle is damaged beyond repair. With reference to FIG. 1, the notification can be received by an insurance computing device 112. In some embodiments, a decision that the motor-vehicle is damaged beyond repair can be made by the insurance company computing device 112, based on data received and/or accessed by the insurance company computing device 112, for example, insurance data 114. In some embodiments, the insurance data can include data related to the insurance policy associated with the damaged vehicle, information received from a claims adjuster and/or the insured party, make of the damaged vehicle, model of the damaged vehicle, year of the damaged vehicle, mileage of the damaged vehicle, pictures of the damaged vehicle, etc.

In some embodiments, the method 122 can include receiving data related to the damaged motor-vehicle, at method block 126. In an example, the received data can include the above mentioned data, among other types of data associated with the damaged motor vehicle. The data can be received and/or accessed via the insurance data, as depicted and discussed in relation to FIG. 1.

In some embodiments, in response to receipt of an indication and/or determination that the vehicle is damaged beyond repair, the method 122 can include determining a price for an option to purchase the damaged vehicle, at method block 128. As discussed herein, in prior methods, a vehicle that was damaged beyond repair was stored, oftentimes outside at a third-party storage facility, while a salvage title was being procured for the damaged vehicle. Oftentimes, the time between when a vehicle was damaged to when the salvage title is obtained could stretch from between 60 to 100 days.

In some embodiments, the price for the option to purchase the vehicle can be determined by an option provider. For example, the price for the option to purchase the vehicle can be determined by an option provider computing device 116. In some embodiments, the option provider can access data stored in a data store 108, as depicted in FIG. 1. The data store 108 can include data that is the same or different from the insurance data 114. In some embodiments, some data can be received by the option provider computing device 116 from the insurance company computing device, related to the damaged vehicle, such as the make, model, year, mileage, damage information, etc. In some embodiments, this data can be stored in data store 108 and accessed by the option provider computing device 116. In some embodiments, additional data over what was provided by the insurance company computing device 112 can be stored and/or accessed via the data store 108. For instance, pricing history for similarly damaged vehicles can be stored in the data store 108 and accessed by the option provider computing device 116.

In some embodiments, the price for the option to purchase the damaged vehicle can be unique to the particular damaged vehicle and is determined based on the received and/or accessed data. For example, as mentioned, the price for the option to purchase the damaged vehicle can be determined from data received from the insurance data 114, data store 108, and/or other data that is accessed (e.g., pricing from similar online sales). In some embodiments, a web scraper can be used to collect data from the internet, regarding similar online sales. Where pricing from similar online sales is used in determining the price of the option to purchase the damaged vehicle, the data can be used in combination with other data that is unique to the particular damaged vehicle. In some embodiments, the different sources of data can be combined to determine a unique price for the option to purchase the damaged vehicle.

In some embodiments, the price for the option to purchase the damaged vehicle can be determined based on a percentage of an anticipated resale value of the damaged vehicle. For instance, in some embodiments, the data from the data store 108, the insurance data 114, and/or other accessed data can be used to determine an anticipated resale value of the damaged vehicle. In some embodiments of the present disclosure, upon determination of the anticipated resale value of the vehicle, the price for the purchase option can be appropriately set, based on the anticipated resale value.

In some embodiments, the method 122 can include causing the price for the option to purchase the damaged vehicle to be presented to a user, along with at least some of the received data. In some embodiments, the option provider computing device 116, in FIG. 1, can provide the option to purchase the damaged vehicle to one of the buyers 110. In some embodiments, causing the option to purchase the damaged vehicle to be presented to the user can include presenting the price for the option to purchase the damaged vehicle to the user via a graphical user interface. As discussed herein, a graphical user interface can be included on a computer and/or mobile device, in some embodiments, and can allow for information to be presented to a user in an interactive manner.

In some embodiments, the method can include presenting the price for the option to purchase the damaged vehicle to a plurality of users. In some embodiments, the option to purchase the damaged vehicle can be presented to one or more of the plurality of users in a manner that allows one of the plurality of users to buy the option for a price that is predetermined by the option provider. For example, a first come, first served approach can be taken, allowing for a first buyer to act on buying the option to win the right to purchase the option. In such an embodiment, the price for the option to purchase the damaged vehicle can be a fixed price.

In some embodiments, the option can be presented to one or more of the plurality of users in a bidding format. For example, a minimum price for the option to purchase the damaged vehicle, which can be uniquely set for a particular vehicle can be determined by the option provider and presented to one or more of the plurality of users. In some embodiments, bidding can be started at the minimum price for the option. Accordingly, the option to purchase the damaged vehicle can be bid on by one or more of the plurality of buyers. In some embodiments, prospective buyers can bid on a price for purchasing the damaged vehicle and the price for the option to purchase the damaged vehicle can be determined based on the amount being bid for purchasing the damaged vehicle. In some embodiments, the price for the option to purchase the damaged vehicle can be determined based on a graduated scale, as discussed herein. In some embodiments, the price for the option to purchase the damaged vehicle can be determined based on a percentage of the price being bid for the damaged vehicle (e.g., 10%, 20%, etc. of the bid price).

In some embodiments, in order to be able to bid on the option to purchase the damaged vehicle, prospective buyers may be required to register with the option provider. In some embodiments, registration with the option provider can include verification of the prospective buyer's email address, bank account, credit, and/or other identification information. In some embodiments, registration of the prospective buyer with the option provider can include a deposit of an amount of money.

In some embodiments, the method 122 can include receiving a selection from the user to buy the option to purchase the damaged vehicle, at method block 132. In an example, the selection can be received by the option provider via the user making a selection on an associated graphical user interface, which can be conveyed to the option provider computing device via link 106.

In some embodiments, upon receiving the selection from the user to buy the option to purchase the damaged vehicle, the vehicle can be delivered to the user. For example, the user can agree to take possession of the vehicle, until a salvage title is procured for the vehicle. In some embodiments, if the prospective buyer does not transport the vehicle from its current location to its own premises, by a defined time, a fee can be charged to the prospective buyer. In some embodiments, the prospective buyer can be required to maintain insurance on the vehicle.

As discussed herein, the amount of time between when a vehicle becomes damaged and a salvage title for the vehicle can be procured can range from between 60 and 100 days, if not longer, during which time the vehicle is oftentimes stored with a third-party storage facility. By allowing the user to take possession of the vehicle, the vehicle can be transported fewer times and fees paid to the third-party storage facility can be avoided. Furthermore, the buyer can choose how they store the vehicle. For example, the buyer can store the vehicle indoors to prevent exposure of the vehicle to the elements. In some circumstances, the buyer can even begin to work on the vehicle, with the intent to purchase the vehicle when the salvage title becomes available. In such a circumstance, although the buyer of the purchase option does not own the vehicle at the point that they start repairing the vehicle and would be investing time and money into the vehicle at the risk of the sale not being completed for an unknown reason; the prospective buyer could begin work at their own risk to enable the vehicle to be sold at a date immediately following successful completion of the sale and transfer of the salvage title to the prospective buyer.

In some embodiments, the option to buy the damaged vehicle provides the buyer of the option the ability to choose whether to exercise their option at a time when the salvage title becomes available. Accordingly, the buyer can chose whether or not to exercise their option to purchase the damaged vehicle. If the buyer does choose to exercise their purchase option, funds can be transferred from the buyer to the option provider, insurance company, and/or another entity for ultimately purchasing the vehicle from the insurance company and obtaining the salvage title. However, the buyer can also choose to not exercise their option to buy the damaged vehicle. In some embodiments, if the buyer chooses to not exercise their option to purchase the damaged vehicle, then the funds for purchasing the option to buy the damaged vehicle, or a portion of those funds, can be retained by the option provider. In some embodiments, to prevent prospective buyers from continually choosing to not exercise their purchase options, certain disciplinary actions (e.g., penalties) can be enforced with respect to the buyer, as discussed herein.

In some embodiments, a title for the damaged vehicle may not be able to be procured for a number of different reasons. Thus, the option to buy the damaged vehicle is a conditional option to buy the damaged vehicle. For example, if the title to the damaged vehicle is not able to be procured, then the purchaser of the option may not be allowed to exercise the option, thus the option can be a conditional option, conditioned upon a title for the damaged vehicle being obtained.

In some embodiments, if the buyer chooses to not exercise their option to purchase the damaged vehicle, the buyer can be held responsible for any fees associated with relocating the vehicle to a location of the option provider's choice. In some embodiments, the buyer may be required to retain the vehicle on their own property until a third party purchases the vehicle.

In some embodiments, when a buyer has rejected their option to buy vehicles a particular number of times, the individual can be prevented from buying future purchase options. For example, when a buyer has refused to exercise their option to buy a vehicle three or more times, the buyer can be refused the opportunity to buy a purchase option for a period of time. In some embodiments, the period of time can be indefinite. In some embodiments, the period of time can be a defined period of time (e.g., 1 week, 1 month, etc.). In some embodiments, the period of time for which a buyer can be restricted from buying purchased options for damaged vehicles can increase after each refusal to exercise their option to buy the vehicle. As an example, after three refusals to exercise their purchase options over the course of a period of time (e.g., 1 year), the buyer can be restricted from the opportunity to buy purchase options for a period of time (e.g., 1 month). After the period of time has passed, the buyer can be put on a probationary period for a period of time, where if they do not exercise their option to buy the damaged vehicles, they can be restricted from the opportunity to buy purchase options for an increasing amount of time (e.g., 2 months).

In some embodiments, based on the volume of options exercised by a particular buyer to purchase damaged vehicles, a number of refusals the particular buyer is permitted can be increased over a period of time and/or number of vehicles purchased. For example, where a first buyer exercised 10 options to buy damaged vehicles over the course of a period of time (e.g., 1 year), the buyer can be granted a first number of refusals (e.g., 3 refusals) to exercise purchase options, without penalty. However, where a second buyer exercised 100 options to buy damaged vehicles over the course of a period of time (e.g., 1 year), the buyer can be granted an increased number of refusals (e.g., 10 refusals). Accordingly, a sliding scale can be adapted, granting a variable number of refusals to buyers, based on how many options the particular buyer has exercised.

Similarly, a price for the option to buy vehicles can be adjusted for particular buyers, based on the number of refusals to exercise options made by the particular buyer. In an example, a buyer can be allowed a number of refusals to exercise options, before a disciplinary action is taken against the buyer. In an instance where a buyer refuses to exercise a particular number of purchase options over a period of time, the price of future purchase options can be increased for that particular buyer. For instance, if a buyer refuses to exercise a number of purchase options, exceeding 3 purchase options, over the course of a year, a price associated with future purchase options can be increased by a particular amount (e.g., percentage). For instance, the price for future purchase options could be increased by 20% for a probationary period of time (e.g., 1 year). If additional refusals were made during the probationary period, the price for future purchase options could be increased even more. After the probationary period, in some embodiments, the increase can be reduced or eliminated, if the individual does not refuse any purchase options, or refuses less than a particular amount of purchase options, during the probationary period.

In some embodiments, in response to a buyer refusing to exercise their purchase one or more purchase options, other types of disciplinary action can be taken. For example, in some embodiments, when a buyer refuses to exercise their purchase options a number of times, exceeding a threshold, a decision can be made to prevent the buyer from buying future purchase options for a period of time (e.g., probationary period). On some embodiments, the period of time can be indefinite, or some other lesser amount of time (e.g., 1 month, 1 year, etc.). In some embodiments, one or more of the disciplinary actions discussed herein can be combined with one another.

In some embodiments, to prevent buyers from not exercising their options, unique options can be sold to buyers, which must be exercised. For example, the buyer would not be able to choose to not exercise the option. In some embodiments, these options could be sold to the buyers for less than an option that the buyer could choose to exercise. Such an arrangement can add predictability to the process for the option provider and/or the insurance company.

In some embodiments, the method can include determining an alternative pricing structure and associated unique purchase option for the damaged vehicle. For example, in some embodiments, the method can include determining a price of scrap metal associated with the damaged vehicle. In some instances, where a residual value of the damaged vehicle is less than a price of scrap metal associated with the damaged vehicle, pricing of the unique purchase option can be aligned with the price of scrap metal. For example, the method can include adjusting the price for the option to purchase the damaged vehicle based on the price of scrap metal exceeding a threshold price and a determined value of the damaged vehicle being less than a defined value. Accordingly, if the option to purchase the damaged vehicle is reflective of its associated value in scrap metal, then the price for the option to purchase the damaged vehicle can be adjusted based on a weight of the damaged vehicle.

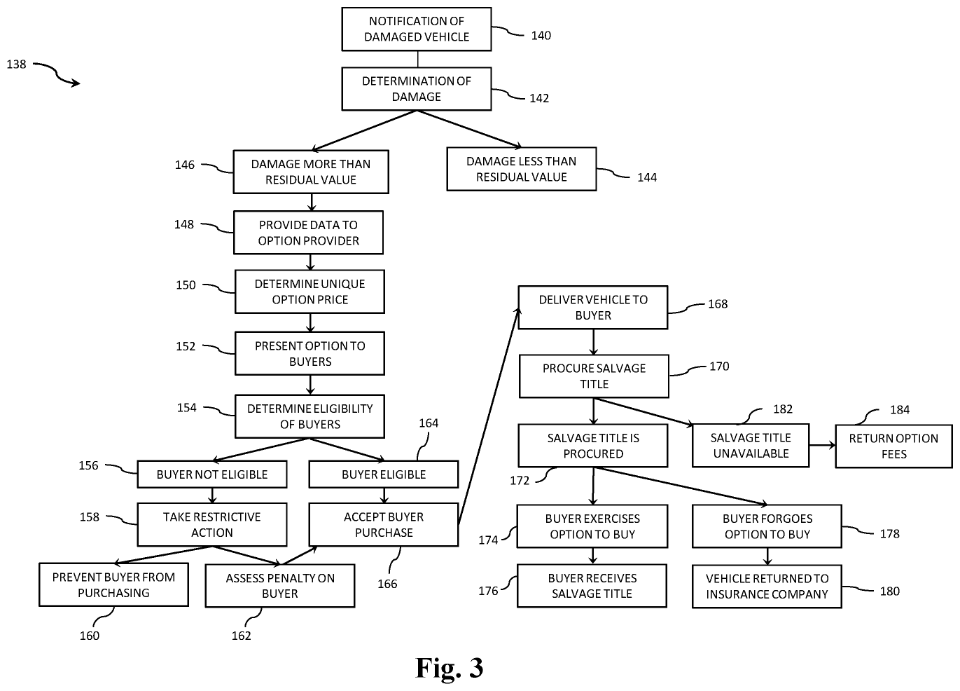

FIG. 3 depicts a flow chart 138 for purchasing a vehicle, according to embodiments of the present disclosure. In some embodiments, one or more of the individual steps in the flow chart 138 can be representative of computer readable instructions that can be executed by one or more of the computing devices discussed herein. In some embodiments, one or more of the individual steps in the flow chart 138 can represent method steps, which can be executed by the one or more computing devices discussed herein. In some embodiments, a notification that a vehicle has been damaged can be received at block 140. In some embodiments, the notification can be received by an insurance company that insures the vehicle, an insurance adjuster, and/or an option provider, as discussed herein. In response to the notification that the vehicle has been damaged, the type, amount, and/or cost associated with the damage can be determined. In some embodiments the determination can be made by an insurance adjuster. In some embodiments, a computing device can be utilized in determining the type, amount, and/or cost associated with the damage. For example, details associated with the damage can be entered into the computing device and a cost associated with the damage can be estimated.

In some embodiments, based on the cost of the damage that the vehicle sustained, a determination can be made, at blocks 144 and 146, of whether the damage exceeds a residual value of the vehicle. For example, a determination can be made that the damage is less than a residual value, at block 144, or a determination can be made that the damage is more than the residual value, at block 146. If the damage is less than a residual value of the vehicle, then a decision can be made to repair the vehicle and/or issue a check to the insured party for repair of the vehicle. If the damage is greater than a residual value of the vehicle, then a decision can be made to provide data to an option provider, at block 148.

In some embodiments, when providing data to an option provider, at block 148, the data can include a make, model, brand, year, mileage, condition, options, details associated with the damage, etc. In an example, where data is received with respect to a plurality of vehicles, the related data for each of the plurality of vehicles can include at least one different data value, with respect to the rest of the plurality of vehicles. For instance, data values with respect to each vehicle can be different from other vehicles. In an example, at least one of a make, model, brand, year, mileage, condition, options, details associated with the damage can be unique to a particular vehicle and not shared with other ones of the plurality of vehicles. From the unique data associated with each vehicle, a unique option price to purchase each vehicle can be generated, at block 150. In some embodiments, no two option prices for the plurality of vehicles can be the same, as a result of the unique data associated with each of the plurality of vehicles. As discussed herein, the option price can be a price payable by a prospective buyer of the damaged vehicle, in order to give them an option to buy the vehicle when the salvage title for the vehicle becomes available.

In some embodiments, the option provider can be a third-party, separate from an insurance company. However, in some embodiments, the option provider can be the insurance company itself. In some embodiments, as disclosed herein, the insurance company can take the roll of the option provider. Thus, the option provider may not be a third-party, separate from the insurance company, since the insurance company takes on the roll of the option provider.

In some embodiments, the unique option to buy the damaged vehicle can be presented to prospective buyers, at block 152. A prospective buyer can include a salvage dealer, vehicle dealership, individual, vehicle repair company, investor, etc. In some jurisdictions, requirements can exist that the prospective buyer be registered (e.g., registered as a salvage dealer). In some embodiments, a determination of the eligibility of a prospective buyer can be made at block 154. In an example, eligible prospective buyers can include those that have preregistered as a buyer and/or have been approved by a provider of the unique option to buy the damaged vehicle. In some embodiments, an eligible buyer can include a buyer that has made an account with the option provider. In some embodiments, an eligible buyer can include a buyer that has deposited a particular amount of money with the option provider and/or undergone a verification with the option provider. For example, an eligible buyer may need to undergo a credit check to be considered eligible.

In some embodiments, a determination can be made that a buyer is not eligible at block 156. In an example, a restrictive action can be taken against the buyer, at block 158. In some embodiments, as discussed herein, a penalty and/or restrictive action can be placed on a buyer that is not eligible.

In some embodiments, a determination can be made whether the buyer is eligible, based on a number of options that have been executed or rejected by the prospective buyer. For example, as discussed herein, a buyer may be restricted from purchasing an option, due to a number of prior options that have been rejected by the buyer. In some embodiments, as discussed herein, the buyer may be eligible to buy the option, but may have a penalty enforced, due to a number of previously rejected options. For example, at block 162, a penalty defined by an increased option price (e.g., 20% increase) can be assessed on the prospective buyer, based on the number of prior rejected options. Upon assessment of a penalty on the prospective buyer, the prospective buyer can still purchase the option, albeit at potentially a higher price. In such an instance, the prospective buyer's bid can be accepted at block 166.

In some embodiments, a buyer may be prevented from purchasing the vehicle, at block 160. In some embodiments, the buyer can be assessed a penalty, at block 162. In some embodiments, a determination can be made that the buyer is eligible and thus has no prior restrictions placed on their ability to purchase an option, at block 164. In such a case, the buyer's bid can be accepted, at block 166. As discussed herein, the unique option can be sold for a fixed price and/or in some circumstances can be bid on. In some embodiments, a reserve price can be determined for the unique option and the option can be bid on for prices above the reserve price. In some embodiments, an option can be presented to users for a price predetermined by the option provider and bidding can further be started on the option at a price below the predetermined price, thus giving a buyer the option to buy the option at a price determined by the option provider, or bid on the option for a lower price, but not be guaranteed a winning bid.

Upon acceptance of the buyer's bid, at block 166, the vehicle can be delivered to the buyer, at block 168. In some embodiments, instructions can be executed by a computing device to send a notification to the buyer to arrange for shipping of the vehicle and/or a notification can be directly sent to a shipping company for shipping the vehicle to the buyer. As discussed herein, while the salvage title is being procured, the vehicle can be stored at a buyer facility, allowing for further inspection by the buyer, storing the vehicle in a manner they see fit, avoiding fees and further damage associated with transportation to and from a third party storage facility, fees associated with storage at the third party storage facility, and/or allowing the buyer to begin work on the vehicle sooner.

In some embodiments, upon delivery of the vehicle to the buyer, a salvage title can be procured, at block 170. As discussed herein, the period of time required for obtaining a salvage title can range from 60 to 100 days, depending on the jurisdiction in which the vehicle is titled and to some extent, the type of vehicle. In order to get the damaged vehicle in the hands of a prospective buyer sooner, thus avoiding transportation costs to a third party storage facility, storage costs, and further damage resulting from transportation and storage, a unique price for an option to purchase the damaged vehicle can be generated and the option can be sold to a buyer, as further discussed herein.

When the salvage title is procured, at 172, the buyer can exercise their option to buy the associated vehicle, at block 174. If the buyer makes the decision to buy the vehicle, funds can be transferred to the option provider, and or directly to the insurance company and the salvage title can be provided to the buyer, at block 176. If the buyer decides to forego their option to buy the vehicle, at block 178, in some embodiments, the insurance company can retain the title of the vehicle. In some embodiments, the entire fee paid for the option to buy the vehicle could be kept by the option provider, or a portion of the fee paid for the option to buy the vehicle could be kept by the option provider and the remainder returned to the buyer.

In some embodiments, if the buyer decides to not buy the vehicle, the physical vehicle can remain at the buyer's location until the vehicle can be sold to a second prospective buyer that would purchase a second option to buy the vehicle. In some embodiments, at this stage, if the buyer decides to not buy the vehicle, the title would have been obtained and the vehicle could be delivered directly to the second prospective buyer with the procured salvage title.

If a salvage title cannot be procured for the damaged vehicle, at block 182, in some embodiments the fees, or a portion thereof, can be returned to the buyer. In some embodiments, if the salvage title cannot be procured, a further option can be provided to the buyer to buy the vehicle for a price determined for the scrap metal associated with the vehicle and/or a part-out cost of the vehicle. In such an instance, a scrap title could be procured for the vehicle.

Although FIG. 3 is discussed in an order of steps (e.g., blocks), in some embodiments, various steps can occur at different locations in the flow diagram. For example, the salvage title can be procured at other locations in the flow diagram, such as after a decision has been made that an amount of damage to the vehicle is more than a residual value of the vehicle, at block 146.

FIG. 4A depicts a diagram of a system 200 for purchasing a vehicle, according to embodiments of the present disclosure. The system 200 can include a data store 202 (e.g., analogous to data store 108 as referenced in FIG. 1), a purchasing system 204, and/or a number of engines. The purchasing system 204 can be in communication with the data store 202. The purchasing system 204 can include a number of engines (e.g., receive engine 206, determine price engine 208, present engine 210, determine eligibility engine 212, determine receive engine 214, etc.). The purchasing system 204 can include additional or fewer engines than illustrated to perform the various functions described herein. The number of engines can include a combination of hardware and programming to perform a number of functions described herein (e.g., accessing and/or aggregating data, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic). In some embodiments, the instructions can be method steps that are executed by the processing resource 232 (FIG. 4B).

The receive engine 206 can include hardware and/or a combination of hardware and programming to receive data related to a damaged vehicle. In some embodiments, the cost of damage to the vehicle can be determine whether the cost of damage exceeds a residual value of the vehicle.

The determine price engine 208 can include hardware and/or a combination of hardware and programming to determine a price for an option to purchase the damaged vehicle. In some embodiments, the price for the option to purchase the damaged vehicle can be unique to the particular damaged vehicle and can be determined based on the received data. As discussed herein, the data associated with each vehicle can be unique to that particular vehicle, thus resulting in the determination of a unique price for the option to purchase the damaged vehicle. For example, in some embodiments, the price for the option to purchase the damaged vehicle can be determined, based on the residual value of the damaged vehicle.

The present engine 210 can include hardware and/or a combination of hardware and programming to present the option to purchase the damaged vehicle to a user. In an example, the option can be presented to a user via a graphical user interface, as discussed herein.

The determine eligibility engine 212 can include hardware and/or a combination of hardware and programming to determine an eligibility of the buyer to purchase the option. As discussed herein, in some embodiments, a user may have previously rejected the opportunity to exercise one or more options, resulting in assessment of a penalty on the buyer.

The receive engine 214 can include hardware and/or a combination of hardware and programming to receive a selection from the buyer to purchase the option, based on their determined eligibility to purchase the option. In some embodiments, the selection can be received by an option provider, as a result of the user making a selection made by a user on a graphical user interface.

FIG. 13B depicts a diagram of an example of a computing device 230 for purchasing a vehicle according to the present disclosure. The computing device 230 can utilize software, hardware, firmware, and/or logic to perform a number of functions described herein.

The computing device 230 can be a combination of hardware and instructions to share information. The hardware, for example can include a processing resource 232 and/or a memory resource 236 (e.g., computer-readable medium (CRM), database, etc.). A processing resource 232, as used herein, can include a number of processors capable of executing instructions stored by the memory resource 236. Processing resource 232 can be integrated in a single device or distributed across multiple devices. The instructions (e.g., computer-readable instructions (CRI)) can include instructions stored on the memory resource 236 and executable by the processing resource 232 to implement a desired function (e.g., determine a source of data, etc.).

The memory resource 236 can be in communication with the processing resource 232. The memory resource, as used herein, can include a number of memory components capable of storing instructions that can be executed by the processing resource 232. Such memory resource 236 can be a non-transitory CRM. Memory resource 236 can be integrated in a single device or distributed across multiple devices. Further, memory resource 236 can be fully or partially integrated in the same device as processing resource 232 or it can be separate but accessible to that device and processing resource 232. Thus, it is noted that the computing device 230 can be implemented on a support device and/or a collection of support devices, on a mobile device and/or a collection of mobile devices, and/or a combination of the support devices and the mobile devices.

The memory 236 can be in communication with the processing resource 232 via a communication link 234 (e.g., path). The communication link 234 can be local or remote to a computing device associated with the processing resource 232. Examples of a local communication link 234 can include an electronic bus internal to a computing device where the memory resource 236 is one of a volatile, non-volatile, fixed, and/or removable storage medium in communication with the processing resource 232 via the electronic bus.

The memory resource 236 can include a number of modules such as a receive module 238, a determine price module 240, a present module 242, a determine eligibility module 244, and a receive module 246. The number of modules 238, 240, 242, 244, 246 can include CRI that when executed by the processing resource 232 can perform a number of functions. The number of modules 238, 240, 242, 244, 246 can be sub-modules of other modules. For example, the receive module 238 and the determine price module 240 can be sub-modules and/or contained within the same computing device. In another example, the number of modules 238, 240, 242, 244, 246 can comprise individual modules at separate and distinct locations (e.g., CRM, etc.).

Each of the number of modules 238, 240, 242, 244, 246 can include instructions that when executed by the processing resource 232 can function as a corresponding engine as described herein. For example, the determine eligibility module 244 can include CRI that when executed by the processing resource 232 can function as the determine eligibility engine 212. For instance, the aggregate vehicle module 244 can include CRI that when executed by the processing resource 232 can cause a computing device to determine an eligibility of the buyer to purchase the option.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a system and method for purchasing a vehicle has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method for purchasing a vehicle, comprising:
receiving an indication that a vehicle is damaged beyond repair;
receiving data related to the damaged vehicle;
determining a price for an option to purchase the damaged vehicle, wherein the price for the option to purchase the damaged vehicle is unique to the particular damaged vehicle and is determined based on the received data;
causing the price for the option to purchase the damaged vehicle to be presented to a user, along with at least some of the received data; and
receiving a selection from the user to buy the option to purchase the damaged vehicle.

2. The method of claim 1, wherein causing the price for the option to purchase the damaged vehicle to be presented to the user includes presenting the price for the option to purchase the damaged vehicle to the user via a graphical user interface.

3. The method of claim 2, wherein the method further includes presenting the price for the option to purchase the damaged vehicle to a plurality of users.

4. The method of claim 1, wherein upon receiving the selection from the user to buy the option to purchase the damaged vehicle, the user agrees to take possession of the vehicle.

5. The method of claim 4, wherein the user agrees to store the vehicle until a salvage title becomes available for the vehicle.

6. The method of claim 1, wherein the price for the option to purchase the damaged vehicle is a fixed price.

7. The method of claim 1, wherein the price for the option to purchase the damaged vehicle is bid on by one or more of a plurality of users.

8. The method of claim 1, wherein the user pays a fee in order to buy the option to purchase the damaged vehicle.

9. The method of claim 1, further comprising:
determining a price of scrap metal associated with the damaged vehicle; and
adjusting the price for the option to purchase the damaged vehicle based on the price of scrap metal exceeding a threshold price and a determined value of the damaged vehicle being less than a defined value.

10. The method of claim 1, wherein the price for the option to purchase the damaged vehicle is adjusted based on a weight of the damaged vehicle.

11. The method of claim 1, wherein the price for the option to purchase the damaged vehicle is based on a residual value of the damaged vehicle.

12. The method of claim 1, wherein the price for the option to purchase the damaged vehicle is based on an auction price for the damaged vehicle.

13. A method for purchasing a vehicle, comprising:
receiving an indication that a plurality of vehicles are damaged beyond repair;
receiving data related to the plurality of damaged vehicles, wherein the data associated with each of the vehicles is unique to the respective vehicle;
determining a price for an option to purchase each of the damaged vehicles, wherein the price for the option to purchase each of the damaged vehicles is unique to each particular damaged vehicle and is determined based on the associated unique data;
causing the price for the option to purchase the damaged vehicle to be displayed to a user, along with at least some of the received data; and
receiving a selection from the user to buy the option to purchase the damaged vehicle.

14. The method of claim 13, further comprising determining a number of times that the user has refused to exercise the option to purchase the damaged vehicle.

15. The method of claim 14, further comprising preventing the user from buying future purchase options for a period of time.

16. The method of claim 13, wherein the data related to each of the plurality of vehicles includes at least one different data value, with respect to the rest of the plurality of vehicles.

17. The method of claim 16, further comprising analyzing the at least one different data value for each of the plurality of vehicles to determine the unique price for the option to purchase each of the damaged vehicles.

18. The method of claim 17, wherein the price for the option to purchase each of the damaged vehicles is different for each of the plurality of damaged vehicles.

19. A non-transitory computer-readable medium storing instructions to purchase a vehicle, executable by a processing resource to:
receive data related to a damaged vehicle, wherein the cost of damage to the vehicle exceeds a residual value of the vehicle;
determine a price for an option to purchase the damaged vehicle, wherein the price for the option to purchase the damaged vehicle is unique to the particular damaged vehicle and is determined based on the received data;
present the option to purchase the damaged vehicle to a user;
determine an eligibility of the buyer to purchase the option; and
receive a selection from the buyer to purchase the option, based on their determined eligibility to purchase the option.

20. The non-transitory computer-readable medium of claim 19, further comprising instructions executable to assess a penalty on the buyer, prior to their selection to purchase the option.

21. The non-transitory computer-readable medium of claim 20, wherein the penalty includes an increased price for the option to purchase the damaged vehicle.

22. The non-transitory computer-readable medium of claim 19, further comprising instructions executable to cause the damaged vehicle to be shipped to the buyer for their possession, until a salvage title is procured for the damaged vehicle.
